(19) United States
(12) Patent Application Publication
(10) Pub. No.: US 2020/0361359 A1
(43) Pub. Date: Nov. 19, 2020

(54) WATERCRAFT TRAILER AND CAMPER COMBINATION SYSTEM

(71) Applicant: Brian K. Jacobs, Daleville, IN (US)

(72) Inventor: Brian K. Jacobs, Daleville, IN (US)

(21) Appl. No.: 16/871,542

(22) Filed: May 11, 2020

Related U.S. Application Data
(60) Provisional application No. 62/848,870, filed on May 16, 2019.

(51) Int. Cl. B60P 3/10; B60P 3/32

(52) U.S. Cl. CPC B60P 3/105; B60P 3/1041; B60P 3/1066; B60P 3/1058; B60P 3/32

(57) ABSTRACT

A watercraft trailer and camper combination system that includes a frame with a first portion and a second portion and a watercraft trailer connected to the first portion of the frame. The watercraft trailer is configured for transporting a watercraft. The watercraft trailer and camper combination system also includes a camper module connected to the second portion of the frame. The camper module is configured for providing a usable enclosure. The watercraft trailer and camper combination system also includes a movable deck movably connected to the frame. The movable deck is configured for moving in between a stowed position for exposing the watercraft trailer and a deployed position for at least partially covering the watercraft trailer.

### CROSS REFERENCE TO RELATED APPLICATIONS

This is a non-provisional application based upon U.S. provisional patent application Ser. No. 62/848,870, entitled “WATERCRAFT TRAILER AND CAMPER COMBINATION”, filed May 16, 2019, which is incorporated herein by reference.

### BACKGROUND OF THE INVENTION

### 1. Field of the Invention

The present invention relates to a watercraft trailer which is towable by a vehicle, and, more particularly, to a multipurpose trailer combination system.

### 2. Description of the Related Art

A watercraft trailer is used to transport a watercraft, such as a boat. The watercraft trailer generally includes a frame, wheels supporting the frame, and a hitching point for coupling to a corresponding hitch of a towing vehicle. The watercraft trailer may also include support members that are connected to the frame for contacting and supporting the hull of the watercraft. The support members may be arranged in a particular shape which substantially matches the shape of the hull of the watercraft.

Watercraft trailers are generally designed to only accomplish the task of transporting the watercraft. Hence, watercraft trailers are not multipurpose units. Thereby, a user may need to additionally tow another trailer or camper unit in order to bring additional supplies or have living accommodations at a desired location. As can be appreciated, it may be costly and generally more difficult to acquire and tow multiple trailers and/or camper units.

What is needed in the art is a cost-effective and multipurpose trailer for transporting a watercraft.

### SUMMARY OF THE INVENTION

The present invention provides a watercraft trailer and camper combination system. The watercraft trailer and camper combination system includes a frame with a first portion and a second portion, a watercraft trailer connected to the first portion of the frame, a camper module connected to the second portion of the frame, and a deck movably connected to the frame. The deck is configured for moving in between a stowed position for exposing the watercraft trailer and a deployed position for at least partially covering the watercraft trailer.

The invention in one form is directed to a watercraft trailer and camper combination system. The watercraft trailer and camper combination system includes a frame with a first portion and a second portion and a watercraft trailer connected to the first portion of the frame. The watercraft trailer is configured for transporting a watercraft. The watercraft trailer and camper combination system also includes a camper module connected to the second portion of the frame. The camper module is configured for providing a usable enclosure. The watercraft trailer and camper combination system also includes a movable deck movably connected to the frame. The movable deck is configured for moving in between a stowed position for exposing the watercraft trailer and a deployed position for at least partially covering the watercraft trailer.

The invention in another form is directed to a method for transporting a watercraft. The method includes an initial step of providing a trailer and camper combination system. The watercraft trailer and camper combination system includes a frame with a first portion and a second portion and a watercraft trailer connected to the first portion of the frame. The watercraft trailer and camper combination system also includes a camper module connected to the second portion of the frame. The camper module is configured for providing a usable enclosure. The watercraft trailer and camper combination system also includes a movable deck movably connected to the frame. The movable deck is configured for moving in between a stowed position for exposing the watercraft trailer and a deployed position for at least partially covering the watercraft trailer. The method further includes a step of positioning the watercraft onto the watercraft trailer. The method further includes a step of transporting the watercraft by the watercraft trailer.

An advantage of the present invention is that the watercraft trailer and camper combination system provides a living space onto a watercraft trailer.

Another advantage is that the deck of the watercraft trailer and camper combination system provides for an expanded living area on the watercraft trailer when the boat is off the watercraft trailer.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a side view of a watercraft trailer and camper combination system;

FIG. 2 is a side view of the watercraft trailer and camper combination system of FIG. 1 with the deck partially extended;

FIG. 3 is a side view of the watercraft trailer and camper combination system of FIGS. 1-2 with a deck railing connected to the frame; and

FIG. 4 is a side view of the watercraft trailer and camper combination system of FIGS. 1-2 with a temporary enclosure connected to the frame.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION OF THE INVENTION

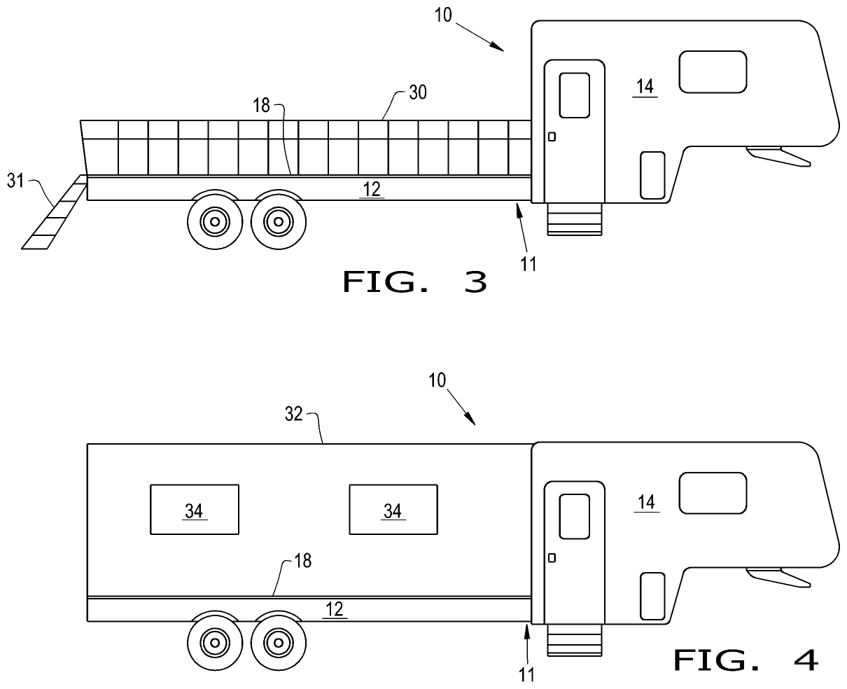

Referring now to the drawings, and more particularly to FIGS. 1-3, there is shown a watercraft trailer and camper combination system 10. The combination system 10 includes a frame 11, a watercraft trailer 12, and a camper module 14. The combination system 10 may also include a movable deck 18 that is movable in between a stowed position (FIG. 1) and a deployed position (FIG. 3).

The frame 11 has a first portion associated with the watercraft trailer 12 and a second portion associated with the camper module 14. The frame 11 is a single body frame. In other words, the frame 11 has a monolithic body which integrates the watercraft trailer 12 and the camper module 14. The frame 11 may include any desired number of wheels (unnumbered). The frame 11 may include a gooseneck hitch configuration. However, the frame 11 may include any desired hitching point to connect to any desired hitch of a towing vehicle. The frame 11 may comprise any desired material.

The watercraft trailer 12 may haul a watercraft 16, such as a boat 16. The watercraft trailer 12 may be connected to the first portion of the frame 11. The watercraft trailer 12 may include support members for supporting the watercraft 16. The watercraft trailer 12 may be located behind the camper module 14.

The camper module 14 provides a usable enclosure. The camper module 14 may be connected to the second portion of the frame 11. The camper module 14 may include one or more doors and windows (unnumbered). The camper module 14 may comprise any desired material. The camper module 14 may have any desired shape and size.

The deck 18 may be movably connected to any desired portion(s) of the frame 11. For example, the deck 18 may be pivotally connected and/or detachably connected to the frame 11. The deck 18 can move in between a stowed position for exposing the watercraft trailer 12 and a deployed position for at least partially covering the watercraft trailer 12. In the stowed position, the deck 18 does not cover the watercraft trailer 12. The deck 18 can be stored on the frame 11, within one or more designated portion(s) of the frame 11, and/or off the frame 11. For instance, the deck 18 may be stowed on the frame 11, in between the watercraft trailer 12 and the camper module 14. In the deployed position, the deck 18 may at least partially cover only a portion or substantially all of the watercraft trailer 12. Therein, the deck 18 in the deployed position provides a usable platform on top of the watercraft trailer 12. The deck 18 may be a single body or uniform deck 18. Alternatively, the deck 18 may be a multi-sectional deck 18 with two or more components.

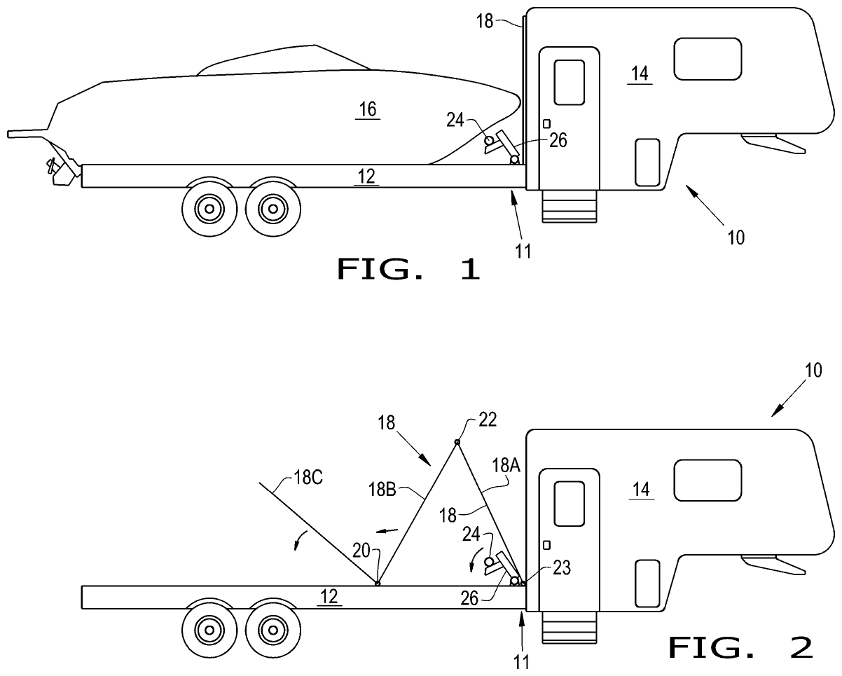

According to one aspect of the present invention, the deck 18 may be configured as a foldable deck 18. For instance, the deck 18 may be a tri-fold foldable deck 18 with three interconnected members 18A, 18B, 18C and hinge points 20, 22, 23 (FIG. 2). The deck 18 may fold out and down, once boat 16 is removed from the watercraft trailer 12. The deck 18 may be configured as a tri-fold foldable deck 18 with three interconnected members 18A, 18B, 18C and hinge points 20, 22, 23. The first member 18A is pivotally connected to the frame 11 at hinge point 23. The second or middle member 18B is pivotally connected to the first member 18A at hinge point 22. The third member 18C is pivotally connected to the second member at hinge point 20. The deck 18 may include rollers or wheels at hinge point 20 that facilitate the movement of deck 18 along the frame 11, i.e., the top of the watercraft trailer 12. As shown, the rollers or wheels are schematically illustrated as part of the hinge point 20. Alternatively, the deck 18 may not include rollers or wheels. In the folded position, the foldable deck 18 is located in between the camper module 14 and the watercraft trailer 12. It should be appreciated that the foldable deck 18 may also be configured as a single fold deck, a bi-fold deck, a quad-fold deck, a quinque-fold deck, etc., with corresponding members and hinge points. It should be appreciated that the foldable deck 18 may coupled to one or both of the sides of the frame 11, e.g. the sides of the watercraft trailer 12. Therein, the foldable deck 18, or multiple sections thereof, may unfold inwardly toward the middle of the watercraft trailer 12.

According to another aspect of the present invention, the deck 18 can be configured as one or more roll-type deck(s). Each roll-type deck may unroll into the deployed position and wrap around itself in the stowed position. The roll-type deck(s) may be connected to the front, rear, and/or sides of the watercraft trailer 12.

The combination system 10 may also include a winch 24 and a movable tower 26 that is movably, e.g. pivotally and/or removably, connected to the frame 11. The winch 24 has a cable which is selectively connectable to the watercraft 16 for pulling the watercraft 16 onto the watercraft trailer 12. The winch 24 is movably connected to the frame 11 via the tower 26. The winch 24 and tower 26 are configured for moving in between a stowed position and an extended or usable position. For instance, the tower 26 may be pivotally connected to the frame 11 such that the user may rotate the tower 26 and winch 24 downwardly into a corresponding receiving area within the frame 11. Additionally or alternatively, the tower 26 may be removably connected to the frame 11 such that the user may disconnect the tower 26 and winch 24 from the frame 11 and store the tower 26 and winch 24 in a designated location. Winch 24 may additionally be coupled with deck 18 for allowing the cable thereof to be attached to deck 18 to allow a controlled stowing or deployment of deck 18. As can be appreciated, the combination system 10 may further include a pulley assembly for coupling the winch 24 to the watercraft 16 and/or the deck 18.

Now, collectively referring to FIGS. 1-3, there is shown a deck railing 30 and a ladder 31 connected to frame 11 and/or deck 18. Railing 30 can provide a barrier around a perimeter of the deck 18 when the deck 18 is in its deployed position. Railing 30 may be moved or separately stored and deployed to enhance the use of deck 18. For example, railing 30 might be folded up from the frame 11 before the deck 18 is deployed, or railing 30 may be slid out from a storage accommodation along camper module 14 or another portion of trailer 12. Railing 30 can also be coupled to a canopy or roof section to thereby provide a shaded or sheltered area above deck 18.

Now, additionally referring to FIG. 4, there is shown another configuration with a temporary enclosure 32 that is placed above the deck 18. The temporary enclosure 32 can be removably connected to the frame 11 and/or the deck 18. The enclosure 32 can cover the frame 11 at any desired time throughout use or storage of the combination system 10. For instance, the enclosure 32 can cover the frame 11, e.g. the watercraft trailer 12, during transport of the watercraft 16 and/or when the combination system 10 is stationary. Additionally, for instance, the enclosure 32 may cover the watercraft trailer 12 when the watercraft 16 resides within the watercraft trailer 12 and/or when the watercraft 16 is off the watercraft trailer 12. Therein, the enclosure 32 may cover the deck 18 when the deck 18 is in its deployed position and/or stowed position. It should be appreciated that the enclosure 32 can provide a protective covering for the watercraft 16. Additionally, it should be appreciated that the enclosure 32 can provide another usable enclosure in addition to the usable enclosure of the camper module 14. The enclosure 32 may have windows 34, which may be screened or be made of a transparent material. The enclosure 32 can be a tent like enclosure 32 or may be panels (or a combination of panels and tent material) that are positioned and locked into place, extending from the back wall of camper module 14, to thereby provide a bug free area for the users of the combination system 10. The enclosure 32 may comprise a single body or multiple body portions.

The present invention also provides a method for transporting a watercraft 16. The method may include providing a trailer and camper combination system 10, as discussed above. Next, the watercraft 16 may be positioned onto the watercraft trailer 12. For instance, the user may couple the winch 24 to the watercraft 16 and lift the watercraft 16 onto the watercraft trailer 12. Thereafter, the user may transport the watercraft 16 from one location to another location. Once at the desired location, the user may unload the watercraft 16 from the watercraft trailer 12. Then, with an empty watercraft trailer 12, the user may move the winch 24 and tower 26 and move the deck 18. Hence, the deck 18 may be moved into its deployed position such that the deck 18 extends over the watercraft trailer 12 and provides a usable platform on top of the watercraft trailer 12. Thereafter, the user may assemble the deck railing 30, the ladder 31, and/or the enclosure 32 onto the frame 11. To transport the watercraft 16 again, the user may remove and/or stow the deck railing 30, the ladder 31, and/or the enclosure 32, move the winch 24 and tower 26 into is usable position, and accordingly move the deck 18 into its stowed position. Then, with the watercraft trailer 12 exposed, the user may again position the watercraft 16 onto the watercraft trailer 12.

It should be appreciated that the watercraft trailer 12 is not simply a watercraft trailer but rather a watercraft trailer 12 with living quarters, i.e., the camper module 14. Likewise, the combination system 10 is not just a camper, it is a camper module 14 with a trailer 12 for hauling a boat 16. Thereby, the combination system 10 is applicable to either the camping industry or the boating industry. For instance, in the camping industry a user can additionally bring a boat 16, and in the boating industry a boater can bring a camper module 14. Users can have their camper module 14 where their boat 16 is, giving them sleeping quarters, a restroom, a changing area, a refrigerator, a generator and an air compressor, boating accessories and additional storage for boating gear and equipment. This combination system 10 provides for expanded living area on the watercraft trailer 12 when the boat 16 is off the trailer 12 and in the water.

It is also contemplated that this boat and camper trailer combination system 10 can also be used with one or multiple Jet-ski's giving the users a place for additional gear and their own personal space with or without campground accessibility, while enjoying their watercrafts.

It should be appreciated that the combination system 10 may be in a fifth wheel, a gooseneck or a bumper pull configuration with electric over hydraulic brakes and/or may be have features to turn an empty watercraft trailer into a covered/usable deck space with full camping privileges while the boat is in the water. Among the features of the present invention is that the watercraft trailer is now kept at the campsite, with all the comforts as a camper, instead of storing the watercraft trailer at the loading dock or some separate trailer storage area. Once reconfigured, the boat hauling area doubles as an outside living space extender to the camper.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A watercraft trailer and camper combination system, comprising:
a frame including a first portion and a second portion;
a watercraft trailer connected to the first portion of the frame, the watercraft trailer being configured for transporting a watercraft;
a camper module connected to the second portion of the frame, the camper module being configured for providing a usable enclosure; and
a movable deck movably connected to the frame and configured for moving in between a stowed position for exposing the watercraft trailer and a deployed position for at least partially covering the watercraft trailer.

2. The watercraft trailer and camper combination system of claim 1, wherein the frame is a single body frame.

3. The watercraft trailer and camper combination system of claim 1, wherein, in the deployed position, the movable deck provides a usable platform on top of the watercraft trailer.

4. The watercraft trailer and camper combination system of claim 1, wherein, in the stowed position, the movable deck does not cover the watercraft trailer.

5. The watercraft trailer and camper combination system of claim 1, wherein the movable deck is a foldable deck that includes a first member pivotally connected to the frame at a first hinge point, a second member pivotally connected to the first member at a second hinge point, and a third member pivotally connected to the second member at a third hinge point.

6. The watercraft trailer and camper combination system of claim 1, wherein the movable deck further includes rollers that are configured for movably connecting the movable deck to the frame.

7. The watercraft trailer and camper combination system of claim 1, further including a winch mounted onto the frame, the winch being configured for connecting to the watercraft and pulling the watercraft onto the watercraft trailer.

8. The watercraft trailer and camper combination system of claim 7, further including a movable tower movably connected to the frame, the movable tower mounting the winch to the frame, the movable tower being configured for moving in between a stowed position and an extended position.

9. The watercraft trailer and camper combination system of claim 1, further including a deck railing removably connected to the first portion of the frame, the deck railing being configured for providing a barrier around a perimeter of the movable deck in the deployed position.

10. The watercraft trailer and camper combination system of claim 1, further including an enclosure removably connected to the first portion of the frame, the enclosure being configured for covering the watercraft trailer.

11. A method for transporting a watercraft, comprising:
providing a trailer and camper combination system, the trailer and camper combination system including a frame including a first portion and a second portion, a watercraft trailer connected to the first portion of the frame, a camper module connected to the second portion of the frame, the camper module being configured for providing a usable enclosure, and a movable deck movably connected to the frame and configured for moving in between a stowed position for exposing the watercraft trailer and a deployed position for at least partially covering the watercraft trailer;
positioning the watercraft onto the watercraft trailer; and
transporting the watercraft by the watercraft trailer.

12. The method of claim 11, wherein the frame is a single body frame.

13. The method of claim 11, further comprising a step of removing the watercraft from the watercraft trailer.

14. The method of claim 13, further comprising a step of deploying the movable deck into its deployed position such that the movable deck provides a usable platform on top of the watercraft trailer.

15. The method of claim 11, wherein, in the stowed position, the movable deck does not cover the watercraft trailer.

16. The method of claim 11, wherein the movable deck is a foldable deck that includes a first member pivotally connected to the frame at a first hinge point, a second member pivotally connected to the first member at a second hinge point, and a third member pivotally connected to the second member at a third hinge point.

17. The method of claim 11, wherein the movable deck further includes rollers that are configured for movably connecting the movable deck to the frame.

18. The method of claim 11, wherein the trailer and camper combination system further includes a winch mounted onto the frame, the winch being configured for connecting to the watercraft and pulling the watercraft onto the watercraft trailer.

19. The method of claim 18, wherein the trailer and camper combination system further includes a movable tower movably connected to the frame, the movable tower mounting the winch to the frame, the movable tower being configured for moving in between a stowed position and an extended position.

20. The method of claim 11, wherein the trailer and camper combination system further includes a deck railing removably connected to the first portion of the frame, the deck railing being configured for providing a barrier around a perimeter of the movable deck in the deployed position.
